(19) United States
(12) Patent Application Publication
(10) Pub. No.: US 2014/0143963 A1
(43) Pub. Date: May 29, 2014

(54) REFILL HEAD FOR AN ORAL CARE IMPLEMENT HANDLE

(71) Applicant: Joseph E. Fattori, East Sandwich, MA (US)

(72) Inventor: Joseph E. Fattori, East Sandwich, MA (US)

(73) Assignee: COLGATE-PALMOLIVE COMPANY, New York, NY (US)

(21) Appl. No.: 14/232,255

(22) PCT Filed: Feb. 3, 2012
(86) PCT No.: PCT/US2012/023779

§ 371 Date: Jan. 11, 2014

Related U.S. Application Data
(60) Provisional application No. 61/506,970, filed on Jul. 12, 2011.

(51) Int. Cl. A61C 17/22; A61C 17/34

(52) U.S. Cl. CPC A61C 17/222; A61C 17/225; A61C 17/3481
USPC 15/22.1; 15/145

(57) ABSTRACT

A toothbrush handle, and toothbrush incorporating the same, wherein the handle comprises a stem to be slidably inserted into a refill head. An aperture in the stem defines a latch having a locking lug that operably mates with a locking lug of the refill head to axially retain the refill head to the handle. A resilient material seals the aperture to provide increased rigidity to the latch.

### CROSS-REFERENCE TO RELATED APPLICATIONS

The present application claims the benefit of U.S. Provisional Patent Application Ser. No. 61/506,970, filed on Jul. 12, 2011, the content of which is hereby incorporated by reference in its entirety.

### FIELD OF THE INVENTION

The present invention relates generally to refill heads for oral care implements, and specifically to the coupling structure for the refill head.

### BACKGROUND OF THE INVENTION

Powered toothbrushes having replaceable heads, commonly referred to as refill heads, are known in the art. Such powered toothbrushes typically include a handle and a refill head that is detachably coupled to the handle. The replaceability of the heads in such powered toothbrushes is desirous because the handle, which includes the motion-inducing circuitry and components, is expensive to manufacture and has a much longer life expectancy than do the cleaning elements, such as bristles, that are on the head. Consumers would not be willing to pay a premium to purchase such powered toothbrushes if they had to be discarded when the bristles or other cleaning elements wore out. Thus, it is now standard in the industry to provide refill heads that can be attached and detached from the handle so that worn out refill heads can be replaced as needed.

Existing refill heads suffer from a number of deficiencies, including complexity of manufacture, the ability to improperly load the refill head to the handle, and inadequate coupling of the refill head to the handle. Thus, a need exist for a refill head having an improved coupling structure.

### BRIEF SUMMARY OF THE INVENTION

The present invention is directed to a handle, and a toothbrush incorporating the same, wherein the handle comprises a stem to be slidably inserted into a refill head. An aperture in the stem defines a latch having a locking lug that operably mates with a locking lug of the refill head to axially retain the refill head to the handle. A resilient material seals the aperture to provide increased rigidity to the latch.

In one embodiment, the invention can be a toothbrush comprising: a handle comprising: a gripping portion; a stem extending from the gripping portion, the stem extending along an axis, the stem comprising a first aperture defining a first latch in the stem, the first latch comprising a first locking lug protruding radially outward from an outer surface of the first latch; and a first resilient material disposed within and sealing the first aperture; a refill head detachably coupled to the handle, the refill head comprising: a head portion comprising a plurality of tooth cleaning elements; a tubular sleeve coupled to the head portion, the tubular sleeve having a cavity in which the stem is disposed, the tubular sleeve comprising a first locking lug protruding radially inward from an inner surface of the tubular sleeve; wherein the first locking lug of the first latch operably mates with the first locking lug of the tubular sleeve to axially retain the stem within the cavity.

In another embodiment, the invention can be a toothbrush handle for detachable coupling to a refill head comprising: a gripping portion; a stem extending from the gripping portion, the stem extending along an axis, the stem comprising a first aperture defining a first latch in the stem, the first latch comprising a first locking lug protruding radially outward from an outer surface of the first latch; and a first resilient material disposed within and sealing the first aperture.

In yet another embodiment, the invention can be a toothbrush handle for detachable coupling to a refill head comprising: a gripping portion; a stem extending from the gripping portion, the stem extending along an axis, the stem comprising a first aperture defining a first latch in the stem, the first latch comprising a first locking lug protruding radially outward from an outer surface of the first latch; and a first resilient material disposed within and sealing the first aperture, the first locking lug remaining exposed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front view of a refill head and a toothbrush handle in alignment for detachable coupling according to one embodiment of the present invention;

FIG. 2 is a longitudinal cross-sectional view of the refill head according to one embodiment of the present invention;

FIG. 3 is a right-side view of a proximal portion of the stem of the toothbrush handle of FIG. 1 illustrating the latch structure of the refill head;

FIG. 4 is a longitudinal cross-sectional view of the refill head and the toothbrush handle of FIG. 1 detachably coupled together according to one embodiment of the present invention;

FIG. 5 is a transverse cross-sectional view of the toothbrush of FIG. 4 taken along view V-V; and

FIG. 6 is a transverse cross-sectional view of the toothbrush of FIG. 4 taken along view VI-VI.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

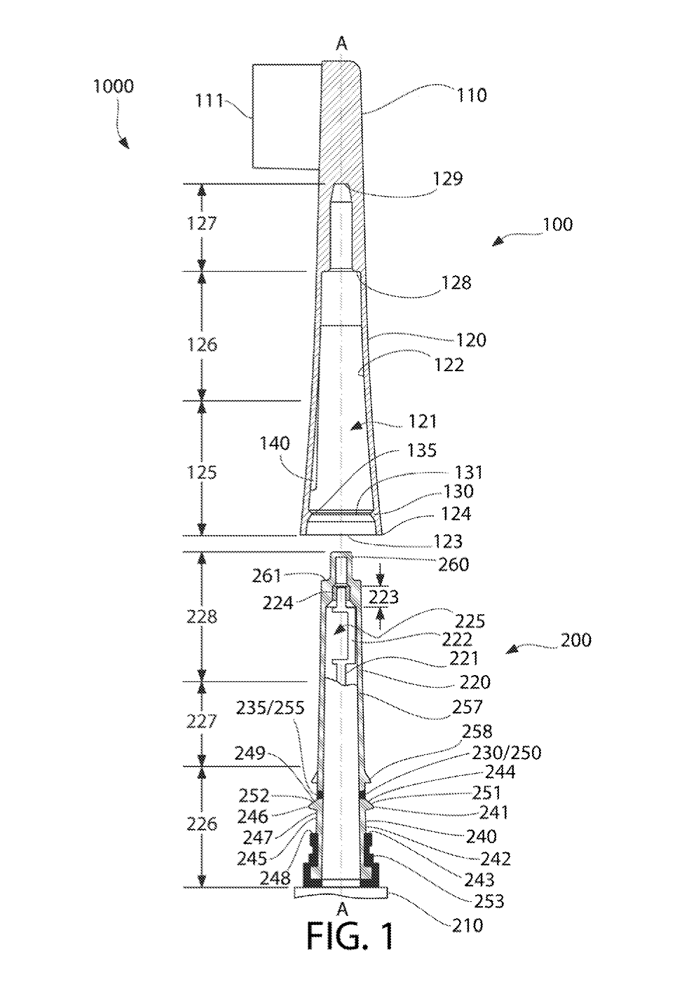

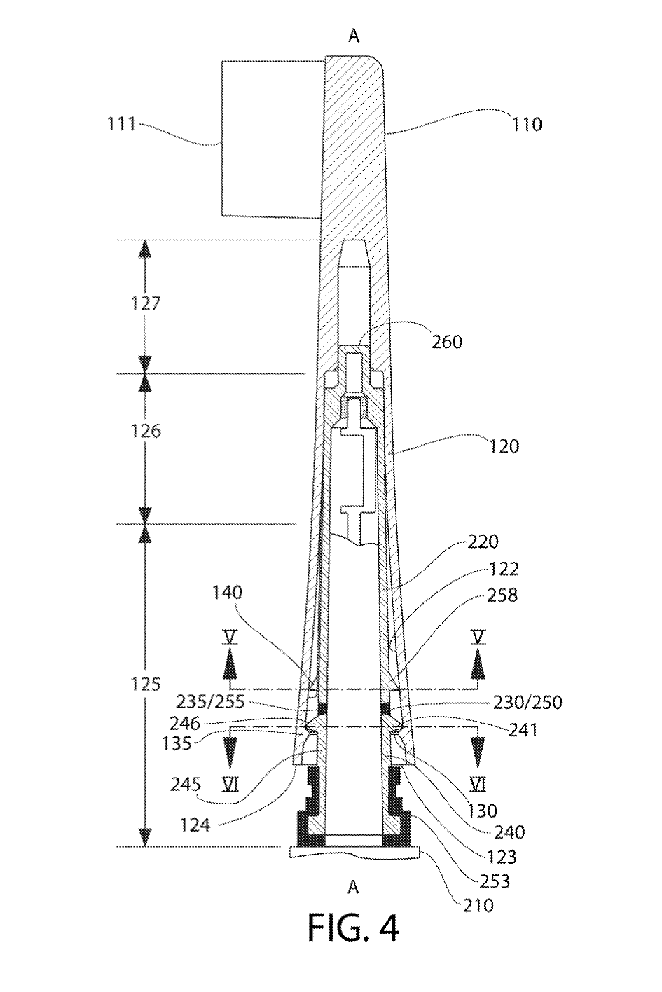

Referring to FIGS. 1 and 4 concurrently, a powered toothbrush 1000 according to one embodiment of the present invention is illustrated. The powered toothbrush 1000 generally comprises a refill head 100 and a handle 200. As discussed in greater detail below, the refill head 100 and the handle 200 are designed so that the refill head 100 can be repetitively coupled and uncoupled from the handle 200. In FIG. 1, the powered toothbrush 1000 is illustrated in a state wherein the refill head 100 is not coupled to the handle 200 but is an axial alignment with the handle 200 so that such coupling can be effectuated. In FIG. 4, the powered toothbrush 1000 is illustrated in a state wherein the refill head 100 is coupled to the handle 200 according to an embodiment of the present invention.

While the invention is exemplified herein as a powered toothbrush 1000, it is to be understood that the inventive concepts discussed herein can be applied to manual toothbrushes that utilize refill heads, or other manual or powered oral care implements, including without limitation tongue cleaners, water picks, interdental devices, tooth polishers and specially designed ansate implements having tooth engaging elements.

Referring now to FIGS. 1, 3 and 4 concurrently, the handle 200 will be described in greater detail. The handle 200 generally comprises a gripping portion 210 (only a small portion of which is exemplified) and a stem 220. The stem 220 extends from the gripping portion 210 along a longitudinal axis A-A.

The gripping portion 210 of the handle 200 is an elongated structure that provides the mechanism by which the user can hold and manipulate the toothbrush 1000 during use. The gripping portion 210 can take on a wide variety shapes, contours and configurations, none of which are limiting of the present invention. Included within the gripping portion 210 is a power source, a motor and the electrical circuitry and components necessary to create a desired motion within the refill head 100. In the exemplified embodiment, the desired motion is a vibratory motion.

The gripping portion 210 also includes the user interface that controls the various operations of the toothbrush 1000, including without limitation turning off and on, changing speeds of the motor, or other functions. The gripping portion 210, in essence, forms a watertight housing for the aforementioned electrical circuitry and mechanical components that need to be protected from moisture.

In the exemplified embodiment, the motion to be transmitted to the head portion 110 of the refill head 100 is a vibratory motion. In order to generate such vibratory motion, the handle 200 comprises a vibratory element, which in the exemplified embodiment is in the form of an eccentric 222 coupled to a drive shaft 221. A proximal portion (not illustrated) of the drive shaft 221 is operably coupled to the electric motor (not illustrated) so that the electric motor can rotate the drive shaft 221. A distal portion 223 of the drive shaft 221 is retained by an annular bearing 224 which is mounted within the stem 220. As the drive shaft 221 is rotated, the eccentric 222, due to its off-center center of gravity, generates vibrations that are transmitted to the stem 220 and to the refill head 100 (discussed in greater detail below). While the eccentric 222 is exemplified as a portion of the drive shaft 221 that is radially offset from the longitudinal axis A-A, the invention is not so limited. In other embodiments, the eccentric 222 may be an offset disc or other offset weight, as is known in the art. As can be seen in FIG. 1, the stem 220 forms a watertight housing having an internal cavity 225 in which the drive shaft 221 and eccentric 222 are housed. Additional details of a suitable vibratory producing handle, and related structure that can be incorporated into the powered toothbrush 1000 of the present invention, can be found in U.S. Patent Application Publication No. 2010/0269275, Shimoyama et al., published Oct. 28, 2010 (filed as U.S. patent application Ser. No. 12/377,355), the entirety of which is hereby incorporated by reference.

The stem 220 comprises a proximal portion 226, a middle portion 227 and a distal portion 228. The proximal portion 226 is the base portion of the stem 220 that is adjacent the gripping portion 210 of the handle 200. The distal portion 228 forms the free end of the stem 220 while the middle portion 227 is located axially between the proximal portion 226 and the distal portion 228. The stem 220 of the handle 200 is generally formed of a material that is rigid, such as a moldable hard plastic. Suitable hard plastics include polymers and copolymers of ethylene, propylene, butadiene, vinyl compounds and polyesters such as polyethylene terephthalate. Of course, the invention is not to be so limited and other moldable hard plastics and/or other materials can be used to form the stem 220 of the handle 200.

Referring to FIGS. 1, 3-4 and 6, the stem 220 further comprises a first aperture 230 that defines a first latch 240 and a second aperture 235 that defines a second latch 245. It should be noted that the present invention is not limited to any specific number of apertures or latches. For example, in alternate embodiments the stem 220 may comprise only one aperture defining a single latch or more than two apertures that define more than two latches.

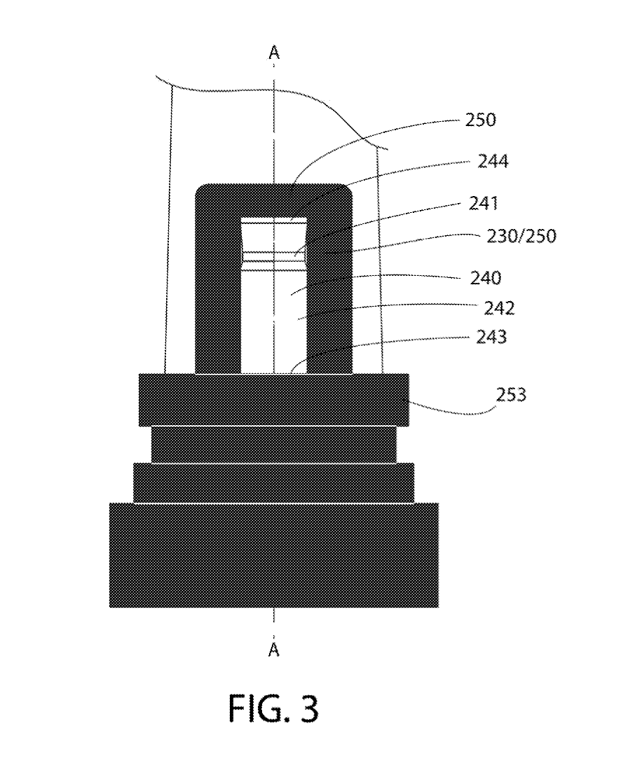

Referring now to FIGS. 1 and 3 concurrently, the first aperture 230 defines the first latch 240 and the second aperture 235 defines the second latch 245. The first and second apertures 230, 235 are openings or passageway in the stem 220. As discussed in greater detail below, the first and second apertures 230, 235 are respectively filled with first and second resilient materials 250, 255. It should be noted that in illustrations, the first and second apertures 230, 235 are filled with the first and second resilient materials 250, 255. However, it is to be understood that prior to being filled with the first and second resilient materials 250, 255, the first and second apertures 230, 235 are openings that form passageways into the internal cavity 225 of the stem 220. Each of the first and second apertures 230, 235 have a closed perimeter. As shown in FIG. 3, the first and second apertures 230, 235 are each a substantially U-shaped aperture. In an alternative embodiment, the first and second apertures 230, 235 can be substantially V-shaped apertures. However, it should be noted that the invention is not so limited and in alternate embodiments the first and second apertures 230, 235 may be any shape suitable for defining a latch.

Referring now to FIGS. 1 and 3-4 concurrently, the first and second latches 240, 245 will be described in more detail. The first latch 240 comprises an outer surface 242 and a first locking lug 241, while the second latch 245 comprises an outer surface 247 and a second locking lug 246. Both the first and second latches 240, 245 are located on the proximate/base portion 226 of the stem 220 and are integrally molded with the stem 220. As best seen in FIG. 3, the first latch 240 extends from a proximal edge 243 to a distal edge 244. Similarly, the second latch 245 extends from a proximal edge 248 to a distal edge 249 (shown in FIGS. 1 and 3). The proximal edge 243 of the first latch 240 forms a living hinge while the distal edge 244 of the first latch 240 forms a free edge. Similarly, the proximal edge 248 of the second latch 245 forms a living hinge while the distal edge 249 of the second latch 245 forms a free edge.

The first locking lug 241 protrudes radially outward from the outer surface 242 of the first latch 240 and comprises an upper surface 251 that is oblique to the axis A-A. Similarly, the second locking lug 246 protrudes radially outward from the outer surface 247 of the second latch 245 and comprises an upper surface 252 that is oblique to the axis A-A. As illustrated in the exemplified embodiments, the first and second locking lugs 241, 246 of the first and second latches 240, 245 are circumferentially spaced-apart on the stem 220. In one embodiment, the first and second locking lugs 241, 246 of the first and second latches 240, 245 are circumferentially spaced-apart by about 180°. However, it should be noted that the circumferential degree by which the latches of the stem 220 are circumferentially spaced-apart can be varied as desired.

As discussed in more detail below, the first and second latches 240, 245 are configured to flex radially inward during the loading and unloading of the handle 200 to the refill head 100 due to contact between the first and second locking lugs 241, 246 of the first and second latches 240, 245 of the stem 220 and the first and second locking lugs 130, 135 of the tubular sleeve 120. Further, the first and second latches 240, 245 are movable between a locked state and an unlocked state. In the locked state, the first and second latches 240, 245 operably mate with the first and second locking lugs of the tubular sleeve 120 to axially retain the stem 220 within the cavity 121 of the tubular sleeve 120 (shown in FIGS. 4 and 6). In the unlocked state, the first and second latches 240, 245 are flexed radially inward due to contact between the first and second locking lugs 241, 246 of the first and second latches 240, 245 and the first and second locking lugs 130, 135 of the tubular sleeve 120 (not shown). As discussed in more detail below, the first and second latches 240, 245 enter the unlocked state during the coupling and uncoupling of the refill head 100 and the handle 200. Therefore, when the refill head 100 is loaded or unloaded from the handle 200, the first and second latches 240, 245 are forced from the locked state to the unlocked state as the first and second locking lugs 130, 135 of the tubular sleeve 120 slide over the first and second locking lugs 241, 246 of the first and second latches 240, 245.

The first and second latches 240, 245 are biased in the locked state. Therefore, when the refill head 100 and handle 200 are coupled together, the first and second latches 240, 245 are biased to keep the first and second locking lugs 241, 246 of the first and second latches 240, 245 operably mated with the first and second locking lugs 24130, 135 of the tubular sleeve 120.

As noted above, the stem 220 further comprises a first resilient material 250 and a second resilient material 255. The first resilient material 250 is disposed within and seals the first aperture 230, while the second resilient material 255 is disposed within and seals the second aperture 235. The first and second latches 240, 245, however, remain exposed and are not covered by the first resilient material 250 and/or the second resilient material 255.

In the exemplified embodiment, the first and second resilient materials 250, 255 are portions of an integral mass of resilient material 253 over-molded to the stem 220. However, the invention is not so limited and in alternate embodiments the first and second resilient materials 250, 255 may be separately molded onto the stem 220. The first and second resilient materials 250, 255 can be an elastomeric material, such as a suitable thermoplastic elastomer (TPE) or other similar materials used in oral care products. The first and second resilient materials 250, 255 may have a hardness durometer measurement ranging between A13 to A50 Shore hardness, although materials outside this range may be used. A suitable range of the hardness durometer rating is between A25 to A40 Shore hardness.

Referring to FIGS. 1 and 3 concurrently, the first and second resilient materials 250, 255 fill the first and second apertures 230, 235 and surround the first and second latches 240, 245 on three sides, thereby making the flexibility of the first and second latches 240, 245 more rigid. As a result, the handle 200 is more difficult to remove from the cavity 121 of the tubular sleeve 120. This is advantageous because it helps to prevent unintended uncoupling of the handle 200 from refill head 100. The first and second resilient materials 250, 255 also perform the function of sealing the first and second apertures 230, 235 to prevent toothpaste and foreign material from entering the cavity 225 of the stem 220. In alternate embodiments, the first and second resilient materials 250, 255 may be molded in different colors to identify different users if the powered toothbrush 1000 is being shared.

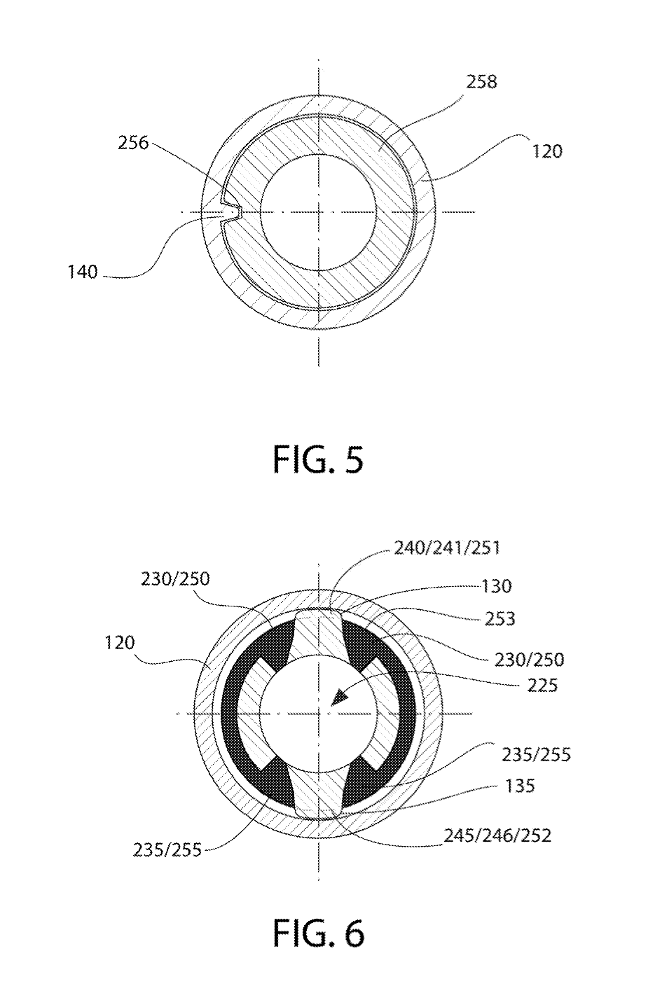

Referring to FIGS. 1, 3 and 5 concurrently, the stem 220 further includes a flange 258 extending radially inward from the outer surface 257. As best seen in FIG. 5, the flange 258 comprises an axial slot 256 formed therein. The flange 258 and the axial slot 256 are configured for maintaining relative rotational orientation between the handle 200 and the refill head 100 as will be described in detail below. Stated simply, the axial slot 256 of the flange 258 is an indexing feature.

The distal portion 228 of the stem 220 further comprises a plug portion 260 extending axially from a shoulder portion 261. The plug portion 260 acts as an axial alignment feature by sliding into a distal axial section 127 of the cavity 121 of the refill head 100 when the refill head 100 is being coupled to the stem 220/handle 100. The shoulder portion 232 can be used to prevent over-insertion of the stem 220 into the cavity 121 during said coupling via contact with an annular should formed in the inner surface of the refill head 100.

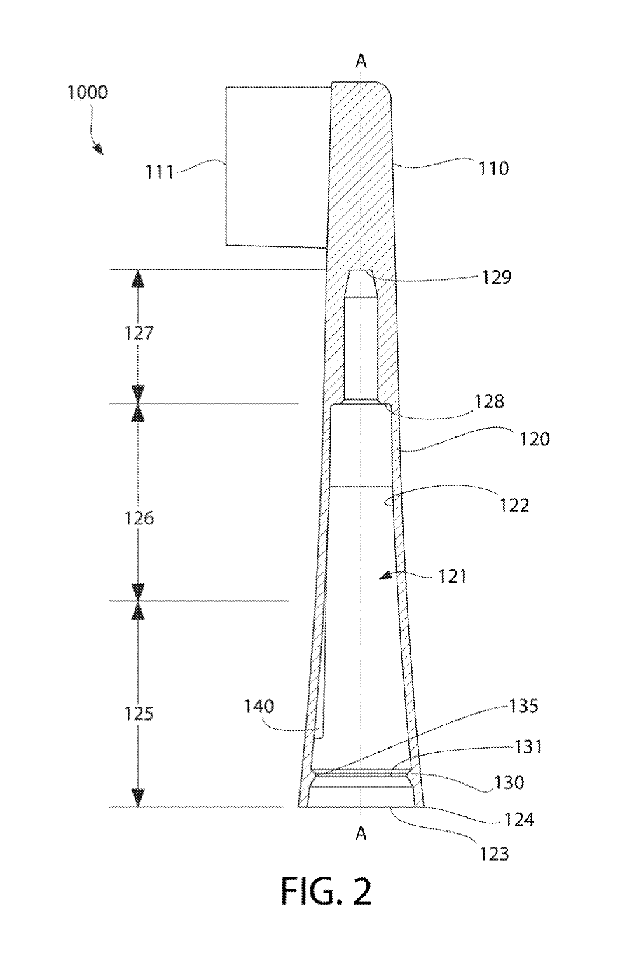

Referring now to FIGS. 1, 2 and 4 concurrently, the refill head 100 will be described in greater detail. As noted above, the refill head 100 is capable of being detachably coupled to the handle 200 so that the refill head 100 can be replaced with a new refill head when it becomes worn out and/or no longer effectively cleans a user's teeth and/or other oral surfaces. By enabling the powered toothbrush 1000 to have refill heads 100 that can be detachably coupled to the handle 200, the entire powered toothbrush 1000 does not need to be replaced when the tooth engaging elements 111 on the refill head 100 become worn out.

The refill head 100 generally comprises a head portion 110 and a tubular sleeve 120 that is coupled to the head portion 110. In the exemplified embodiment, the tubular sleeve 120 and the head portion 110 of the refill head 100 are integrally formed as a single unitary structure using a molding, milling, machining or other suitable process. However, in other embodiments the head portion 110 and the tubular sleeve 120 of the refill head 100 may be formed as separate components which are operably connected at a later stage of the manufacturing process by any suitable technique known in the art, including without limitation thermal or ultrasonic welding, a tight-fit assembly, a coupling sleeve, threaded engagement, adhesion, or fasteners.

The head 100 of the powered toothbrush 1000 comprises a collection of oral cleaning elements such as tooth cleaning elements 110 extending therefrom for cleaning and/or polishing contact with an oral surface and/or interdental spaces. In the exemplified embodiment, the tooth cleaning elements 110 are generically illustrated. While the collection of tooth cleaning elements 110 is suited for brushing teeth, the collection of tooth engaging elements 110 can also be used to polish teeth instead of or in addition to cleaning teeth. As used herein, the term “tooth cleaning elements” is used in a generic sense to refer to any structure that can be used to clean, polish or wipe the teeth and/or soft oral tissue (e.g. tongue, cheek, gums, etc.) through relative surface contact. Common examples of “tooth cleaning elements” include, without limitation, bristle tufts, filament bristles, fiber bristles, nylon bristles, spiral bristles, rubber bristles, elastomeric protrusions, flexible polymer protrusions, combinations thereof and/or structures containing such materials or combinations. Suitable elastomeric materials include any biocompatible resilient material suitable for uses in an oral hygiene apparatus. To provide optimum comfort as well as cleaning benefits, the elastomeric material of the tooth or soft tissue engaging elements has a hardness property in the range of A8 to A25 Shore hardness. One suitable elastomeric material is styrene-ethylene/butylene-styrene block copolymer (SEBS) manufactured by GLS Corporation. Nevertheless, SEBS material from other manufacturers or other materials within and outside the noted hardness range could be used.

The tooth cleaning elements 110 of the present invention can be connected to the head 100 in any manner known in the art. For example, staples/anchors, in-mold tufting (IMT) or anchor free tufting (AFT) could be used to mount the cleaning elements/tooth engaging elements. In AFT, a plate or membrane is secured to the brush head such as by ultrasonic welding. The bristles extend through the plate or membrane. The free ends of the bristles on one side of the plate or membrane perform the cleaning function. The ends of the bristles on the other side of the plate or membrane are melted together by heat to be anchored in place. Any suitable form of cleaning elements may be used in the broad practice of this invention. Alternatively, the bristles could be mounted to tuft blocks or sections by extending through suitable openings in the tuft blocks so that the base of the bristles is mounted within or below the tuft block.

Referring to FIGS. 1-4 concurrently, the tubular sleeve 120 will be described in greater detail. The tubular sleeve 120 comprises an inner surface 122 that forms an internal cavity 121 that extends along the longitudinal axis A-A. The cavity 121 is sized and shaped to accommodate the stem 220 of the handle 200 so that the refill head 100 can be detachably coupled to the handle 200. The tubular sleeve further comprises an opening 123 at the proximal end 124 that provides a passageway into the cavity 121 so that the stem 220 can be axially translated into and out of the cavity 121 via the opening 123.

The cavity 121 comprises a proximal axial section 125, a middle axial section 126, and a distal axial section 127. The proximal axial section 125 extends from the opening 123 to the middle axial section 126. The proximal axial section 125 has a tapered transverse cross-sectional area along its length moving from the opening 123 to the middle axial section 126. The middle axial section 126 extends from the proximal axial section 125 to a shoulder 128 formed in the inner surface 122. The middle axial section 126 has a substantially constant transverse cross-sectional area. However, in alternate embodiments, the middle axial section 126 may also have a tapered transverse cross-sectional area along its length. The distal axial section 127 extends from the shoulder 128 to an end wall 129. The distal axial section 127 has a reduced cross-sectional area in comparison to the middle axial section 126, even at the middle axial section's 126 smallest transverse cross-sectional area.

As mentioned above, the refill head 100 further comprises a first locking lug 130 and a second locking lug 135. The first and second locking lugs 130, 135 are disposed within the cavity 121 and coupled to the tubular sleeve 120. More specifically, the first and second locking lugs 130, 135 are disposed within the proximal axial section 125 of the internal cavity 121. The first and second locking lugs 130,135 are formed into the tubular sleeve 120 and protrude radially inward from the inner surface 122 of the tubular sleeve 120. As noted above, the first and second locking lugs 130, 135 of the tubular sleeve 120 are configured to operably mate with the first and second locking lugs 241, 246 of the first and second latches 240, 245 of the stem 220 to axially retain the stem 220 within the cavity 121 of the tubular sleeve 120. In one embodiment, the first and second locking lugs 130, 135 of the tubular sleeve are arranged in a circumferentially spaced apart manner in the cavity 121. However, in the exemplified embodiments, the first and second locking lugs 130, 135 of the refill head 100 are portions of an annular flange 131 protruding from the inner surface 122 of the tubular sleeve 120.

Referring now to FIGS. 1, 2 and 5 concurrently, the tubular sleeve 120 further comprises an axial rib 140. The axial rib 140 is a protuberance that extends radially inward from the inner surface 122 of the tubular sleeve 120. The axial rib 140 tapers from the proximal axial section 125 to the middle axial section 126. As mentioned above and illustrated in FIGS. 5, the axial rib 140 is configured to mate with the axial slot 256 of the flange 258 of the stem 220 to maintain relative rotational orientation between the stem 220 and the tubular sleeve 120. Therefore, when the head 100 and handle 200 are coupled together, the inner surface 122 of the tubular sleeve 120 and the outer surface 257 of the stem 220 are keyed to maintain relative rotational orientation between the stem 220 and the tubular sleeve 120.

A method of coupling and uncoupling the refill head 100 and the handle 200 will be described. In FIG. 1, the powered toothbrush 1000 is illustrated wherein the refill head 100 is not coupled to the handle 200, but is in axial alignment with the handle 200 so that such coupling can be effectuated. To assemble the refill head 100 to the handle 200, the tubular sleeve 120 is placed on the stem 120 and rotated until the axial rib 140 aligns with the axial slot 256 of the flange 258. Once aligned, the refill head 100 is pressed downward onto the stem 220 of the handle 200. As the refill head 100 is being pressed downward onto the stem 220, the first and second locking lugs 241, 246 of the first and second latches 240, 245 of the stem 220 are pressed inwardly stretching the first and second resilient materials 250, 255 as the first and second locking lugs 241, 246 move over the first and second locking lugs 130, 135 of the tubular sleeve 120. After the first and second locking lugs 241, 246 move over the major diameter of the first and second locking lugs 130, 135 of the tubular sleeve 120, the first and second locking lugs 241, 246 snap back into the locked state and in position above the first and second locking lugs 130, 135 of the tubular sleeve 120. Since the first and second latches 240, 245 are biased in the locked state, the first and second locking lugs 241, 246 operably mate with the first and second locking lugs 130, 135 of the tubular sleeve 120 to axially retain the stem 220 within the cavity 121. Further, since the axial rib 140 is aligned with the axial slot 256, relative rotation orientation between the stem 220 and the tubular sleeve 120 is maintained.

Referring to FIG. 4, it should be noted that when the refill head 100 is coupled to the handle 200, only the distal section 228 of the stem 220 is in intimate contact with the inner surface 122 of the tubular sleeve 120, thereby minimizing vibration below the distal section 228 of the stem 220. This minimizes the vibration felt by the gripping portion 210 of the handle 200. The present design minimizes contact between the stem 220 and the tubular sleeve 120 below the distal section 228 of the stem 220 by utilizing the first and second latches 240, 245 of the stem 220 that has minimal contact with the inner surface 122 of the tubular sleeve 120.

To decouple the refill head 100 from the stem 220 of the handle 200 of the powered toothbrush 1000, the consumer pulls upward on the refill head 100 causing the first and second locking lugs 241, 246 of the first and second latches 240, 245 to be pressed inwardly, allowing the first and second latches 240, 245 to move over the first and second locking lugs 130, 135 of the tubular sleeve 120.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the foregoing description and drawings represent the exemplary embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A toothbrush comprising:
a handle comprising:
a gripping portion;
a stem extending from the gripping portion, the stem extending along an axis, the stem comprising a first aperture defining a first latch in the stem, the first latch comprising a first locking lug protruding radially outward from an outer surface of the first latch; and
a first resilient material disposed within and sealing the first aperture;
a refill head detachably coupled to the handle, the refill head comprising:
a head portion comprising a plurality of tooth cleaning elements;
a tubular sleeve coupled to the head portion, the tubular sleeve having a cavity in which the stem is disposed, the tubular sleeve comprising a first locking lug protruding radially inward from an inner surface of the tubular sleeve;
wherein the first locking lug of the first latch operably mates with the first locking lug of the tubular sleeve to axially retain the stem within the cavity.

2. The toothbrush according to claim 1 further comprising:
the stem further comprising a second aperture defining a second latch in the stem, the second latch comprising a second locking lug protruding radially outward from an outer surface of the second latch, the first and second latches arranged in a circumferentially spaced apart manner on the stem; and
a second resilient material disposed within and sealing the second aperture;
the refill head further comprising a second locking lug protruding radially inward from the inner surface of the tubular sleeve; and
wherein the second locking lug of the second latch operably mates with the second lug of the tubular sleeve to axially retain the stem within the cavity.

3. The toothbrush according to claim 2 wherein the first and second resilient materials are portions of an integral mass of resilient material over-molded to the stem.

4. The toothbrush according to claim 2 wherein the first and second locking lugs of the first and second latches are circumferentially spaced-apart by about 180°.

5. The toothbrush according to claim 2 wherein the first and second locking lugs of the refill head are portions of an annular flange protruding from the inner surface of the tubular sleeve.

6. (canceled)

7. The toothbrush according to claim 1 wherein the first latch extends from a proximal edge to a distal edge, the proximal edge forming a living hinge and the distal edge being a free edge.

8. The toothbrush according to claim 1 wherein the first locking lug of the first latch comprises an upper surface that is oblique to the axis.

9. (canceled)

10. The toothbrush according to claim 1 wherein the stem comprises an axial slot, the tubular sleeve comprises an axial rib that mates with the axial slot to maintain relative rotational orientation between the stem and the tubular sleeve.

11. The toothbrush according to claim 1 wherein the first latch is integrally molded with the stem.

12. The toothbrush according to claim 1 wherein the first latch flexes radially inward during loading and unloading of the refill head to the handle due to contact between the first locking lug of the stem and the first locking lug of the first latch.

13. The toothbrush according to claim 1 wherein the first resilient material is a thermoplastic elastomer and the stem is formed of a hard plastic.

14. The toothbrush according to claim 1 wherein the first latch is biased in a locked state in which the first locking lug of the first latch operably mates with the first locking lug of the tubular sleeve to axially retain the stem within the cavity

15. (canceled)

16. (canceled)

17. The toothbrush according to claim 1 wherein the cavity of the tubular sleeve tapers from a proximal end of the cavity to a distal end of the cavity, the proximal end of the cavity having an opening for receiving the stem.

18. The toothbrush according to claim 1 wherein the handle comprises a power source and a vibratory element operably coupled to the power source.

19. (canceled)

20. (canceled)

21. The toothbrush according to claim 1 wherein the cavity comprises a proximal axial section, a middle axial section, and a distal axial section, the first latch located within the proximal axial section, the stem comprising an alignment plug extending into the distal axial section.

22. A toothbrush handle for detachable coupling to a refill head comprising:
a gripping portion;
a stem extending from the gripping portion, the stem extending along an axis, the stem comprising a first aperture defining a first latch in the stem, the first latch comprising a first locking lug protruding radially outward from an outer surface of the first latch; and
a first resilient material disposed within and sealing the first aperture.

23. The toothbrush handle according to claim 22 further comprising:
the stem further comprising a second aperture defining a second latch in the stem, the second latch comprising a second locking lug protruding radially outward from an outer surface of the second latch, the first and second latches arranged in a circumferentially spaced apart manner on the stem; and
a second resilient material disposed within and sealing the second aperture.

24. The toothbrush handle according to claim 23 wherein the first and second resilient materials are portions of an integral mass of resilient material over-molded to the stem.

25. The toothbrush handle according to claim 23 wherein the first and second locking lugs of the first and second latches are circumferentially spaced-apart by about 180°.

26. (canceled)

27. (canceled)

28. The toothbrush handle according to claim 23 wherein the first and second latches are integrally molded with the stem.

29. The toothbrush handle according to claim 23 wherein the first and second latches flex radially inward during loading and unloading of a refill head to the toothbrush handle.

30. The toothbrush handle according to claim 23 wherein the first and second resilient materials are a thermoplastic elastomer and the stem is formed of a hard plastic.

31. The toothbrush handle according to claim 23 wherein the first and second latches are biased in a locked state.

32. (canceled)

33. (canceled)

34. The toothbrush handle according to claim 22 wherein the handle comprises a power source and a vibratory element operably coupled to the power source.

35. (canceled)

36. A toothbrush handle for detachable coupling to a refill head comprising:
a gripping portion;
a stem extending from the gripping portion, the stem extending along an axis, the stem comprising a first aperture defining a first latch in the stem, the first latch comprising a first locking lug protruding radially outward from an outer surface of the first latch; and
a first resilient material disposed within and sealing the first aperture, the first locking lug remaining exposed.
